(19) United States
(12) Patent Application Publication
(10) Pub. No.: US 2014/0093621 A1
(43) Pub. Date: Apr. 3, 2014

(54) PET FOOD

(71) Applicants: Junya Sakoda, Hyogo-ken (JP); Takahiro Usui, Hyogo-ken (JP)

(72) Inventors: Junya Sakoda, Hyogo-ken (JP); Takahiro Usui, Hyogo-ken (JP)

(21) Appl. No.: 14/036,213

(22) Filed: Sep. 25, 2013

(30) Foreign Application Priority Data
Sep. 28, 2012 (JP) 2012-218334
Mar. 29, 2013 (JP) 2013-074484

(51) Int. Cl. A23K 1/18

(52) U.S. Cl. CPC A23K 1/186
USPC 426/98; 426/442; 426/623; 426/635

(57) ABSTRACT

A pet food comprising an aggregate of granules, wherein 60% or more of the granules in the aggregate have a hardness of 2.5 kgw or lower immediately after being soaked in diluted hydrochloric acid (pH 2.5) having a temperature of 20 to 25° C. for 10 minutes.

### BACKGROUND OF THE INVENTION

1. Field of the Invention

The present invention relates to a pet food. More specifically, the invention relates to a pet food capable of reducing vomiting of pets after meals.

Priority is claimed on Japanese Patent Application No. 2012-218334, filed Sep. 28, 2012, and Japanese Patent Application No. 2013-074484, filed Mar. 29, 2013, the content of which is incorporated herein by reference.

2. Description of Related Art

In order to provide a comprehensive nutritional diet for pets, a method of manufacturing a pet food with improved palatability by granulating a pet food composition containing a blend of nutritionally balanced ingredients, heating the granules to alphatize the starch component and dry the granules, and then subjecting the granules to a frying treatment in oil at a temperature of not more than 180° C. has already been disclosed (Patent Document 1). Further, a method of manufacturing a pet food in which a granulated pet food is molded into a flat plate shape using an extruder has also been disclosed (Patent Document 2).

### DOCUMENTS OF RELATED ART

### Patent Documents

[Patent Document 1] Japanese Unexamined Patent Application, First Publication No. Sho 64-39953
[Patent Document 2] Japanese Patent (Granted) Publication No. 3,793,845

### SUMMARY OF THE INVENTION

Cats groom themselves by licking their hair with their tongues, and thus they have a tendency to vomit hairballs accumulated in their bodies. However, in addition to the vomiting of hairballs, sometimes cats vomit pet food within 1 hour after eating. Even in healthy cats not having kidney disease or the like, such vomiting may occur more often with aging. For example, about one out of two cats between the ages of 7 to 9 years old routinely experience vomiting (a vomiting rate of 50%).

The present invention has been developed in light of the above circumstances and has an object of providing a pet food to reduce vomiting in pets after meals.

If vomiting has occurred within about 1 hour after eating and the color of the vomit is clear or light yellow, it is apparent that the pet food did not mix well with bile, that is, the food has been thrown up after it had arrived in the stomach or the upper duodenum. Such vomiting occurred in spite of the fact that cats usually have good digestive ability, and it has been thought that the reason for such vomiting has been because pet foods, which have still been hard, have retained in stomachs or upper duodenums, and stimulate the gastric wall or intestinal walls to induce vomiting.

The present inventors have found that, a pet food to reduce vomiting after meals can be obtained by controlling the hardness of the pet food after being soaked in diluted hydrochloric acid for one hour, and thereby the present invention has completed. The present invention will be described below.

(1) A pet food comprising an aggregate of granules, wherein 60% or more of the granules in the aggregate have a hardness of 2.5 kgw or lower immediately after being soaked in diluted hydrochloric acid (pH 2.5) having a temperature of 20 to 25° C. for 10 minutes.

(2) The pet food disclosed above in (1), wherein 40% or more of the granules in the aggregate have a hardness of 1.3 kgw or lower.

(3) The pet food disclosed above in (1) or (2), wherein a water content of the granules before soaking is 7.0 to 11.0% by weight.

(4) The pet food disclosed above in any one of (1) to (3), which contains glycerin or lignocellulose.

(5) The pet food disclosed above in any one of (1) to (4), wherein a surface of the granules is coated with grease.

(6) The pet food disclosed above in any one of (1) to (5), wherein the granules are in the form of a pellet which has a minor axis of 3 to 25 mm, a major axis of 3 to 25 mm, and a thickness of 3 to 20 mm.

(7) The pet food disclosed above in any one of (1) to (6), wherein the pet food is a food for cats.

According to the pet food of the present invention, vomiting in pets after meals can be reduced, which contributes to pet health maintenance.

### BRIEF DESCRIPTION OF THE DRAWINGS

FIG. 1 is an example of masticatory waveforms obtained by measuring the physical properties of a pet food in a physical property measuring instrument.

FIG. 2 is a flow chart indicating an example of the method of manufacturing the pet food according to the first embodiment.

### DETAILED DESCRIPTION OF THE INVENTION

### Pet Food

### First Embodiment

A pet food according to a first embodiment of the present invention consists of a formed assembly of granules, wherein 60% or more of granules in the assembly have a hardness of 2.5 kgw or less immediately after being soaked in diluted hydrochloric acid (pH 2.5) having a temperature of 20 to 25° C. for 10 minutes. Here, “immediately after being soaked” means within 1 to 2 minutes after the pet food is removed from the diluted hydrochloric acid.

The diluted hydrochloric acid described above is prepared by dropwise adding 1 normal (N) hydrochloric acid to distilled water, and adjusting the pH to 2.5 (at 20 to 25° C.).

The hardness of the pet food described above after being soaked in the aforementioned diluted hydrochloric acid for 10 minutes is deemed equivalent to the hardness of a pet food which has been eaten and retained in the stomach. When the hardness is 2.5 kgw or less, the physical stimulation of the gastric wall can be reduced, and thus vomiting of pets after meals can be suppressed.

When a greater number of granules contained in the pet food have a hardness as described above, vomiting after meal can further be suppressed. Specifically, it is preferable that 60% or more of the granules have the hardness described above. It is also possible that 100% of the granules have the hardness described above.

60% or more of the granules contained in the pet food described above may have a hardness of 2.5 kgw or less. It is preferable that 60% or more of the granules contained in the pet food described above have a hardness of 2.5 kgw or less and preferably 40% or more of the granules have a hardness of 1.3 kgw or less, and more preferably 50% or more of the granules have a hardness of 1.3 kgw or less. Note that the lower limit value of the hardness described above is 0.0 kgw (equal to or less than measurement accuracy).

The hardness of granules of the pet food can be measured by using the physical property measuring instrument described below, and a numerical value indicating that the hardness can be determined by a masticatory waveform obtained by a measurement under the following measurement conditions.

### <Physical Property Measuring Instrument>

Manufacturing company: TAKETOMO ELECTRIC, Inc., Equipment name: TEXTUROMETER (model number: GTX-2).

### <Measurement Condition>

Plunger: a disk having a diameter of 20 mm and a surface contact with the pet food being flat (“chromium 20 mm diameter”),

Platform: flat plate, 2 mm clearance (maximum compression point), 1 V output, BITE SPEED: LOW (6 times/minutes), frequency of mastication: one time mastication.

### <Measurement Method>

One granule of a pet food immediately after being soaked in the aforementioned diluted hydrochloric acid for 10 minutes is placed on the flat plate, and a load is applied from the upper side by pushing the plunger onto the granule. At this time, the granule is crashed until a distance between the plunger and the platform becomes 2 mm (clearance). The measurement is completed within 1 to 2 minutes after the pet food is removed from the diluted hydrochloric acid.

<Readout of Numerical Value from Masticatory Waveform>

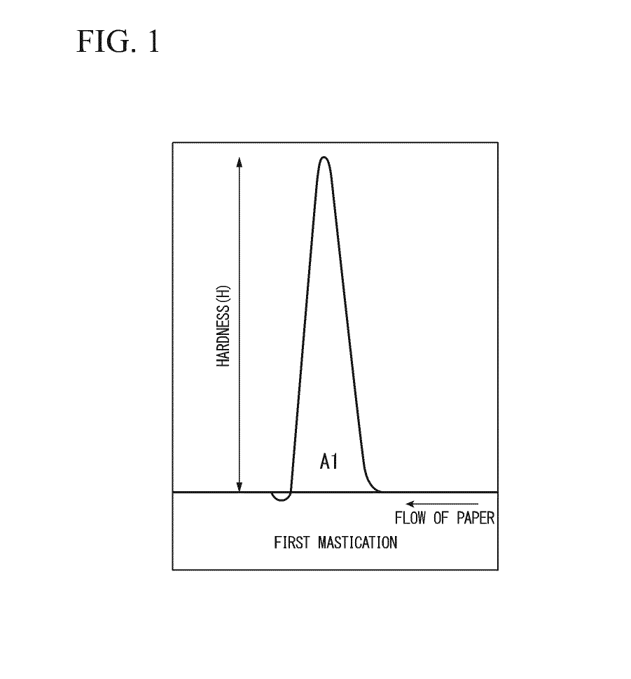

The hardness is obtained from the masticatory waveform shown in FIG. 1 as follows.

Hardness (H): the maximum value of the height of the waveform (peak A1) at the first mastication.

Each measurement value in the masticatory waveform shown in FIG. 1 refers to the following.

The hardness (H) represents a degree of physical hardness (hardness) of the pet food, and refers to the maximum test pressure when load is given to the pet food by the plunger.

By multiplying a numerical value of the hardness (kgw) obtained from a masticatory waveform measured with the TEXTUROMETER (model number: GTX-2) described above by 9.8, the numerical value unit of the hardness can be converted to Newton (N).

When any physical property•measurement equipments (TEXTUROMETERs) other than the TEXTUROMETER (model number: GTX-2) described above are employed, the hardness of the pet food according to the present invention can be obtained based on a masticatory waveform obtained by measuring under the same measurement condition described above or under conditions compatible thereto.

The method to obtain the hardness explained in the present specification is compliant with the texture profile by Szczesniak (Szczesniak, A. S.: J. Food Sci., 28, 385 (1963)). At the General Foods Corporation in the USA, Szczesniak has organized and schematized terminologies relating to texture, and has represented correlations between measurement values obtained by the TEXTUROMETER and organoleptic evaluation values determined by humans (Szczesniak, A. S., Blandt, M. A. & Freidman, H. H.: J. Food Sci., 28, 397 (1963)).

The hardness of the pet food before water absorption can also be measured with the TEXTUROMETER (model number GTX-2) described above. The hardness of the pet food before water absorption is not particularly limited and is usually from 5.0 to 9.0 kgw, although it depends on the water content of the pet food. A preferable hardness before water absorption is, for example, from 6.0 to 8.0 kgw.

The water content of the pet food is not particularly limited and is suitably from 8.0 to 10.0% by weight, which is in the same range of those of conventional dry pet foods, or is 7.0 to 11.0% by weight, which is in the range close thereto.

### <Measurement of Water Content>

A water content (% by weight) of the pet food described above can be obtained by a method of heating and drying under normal pressure.

### <<Method of Heating and Drying Under Normal Pressures>>

The weight of an aluminum weighing can (W1 gram) is preliminary measured as a constant weight value. A sample is placed in the aluminum weighing can, and weighed (W2 gram). Then the sample is dried at 135° C. for 2 hours by employing a warm air dryer with controlled circulation. After the sample is cooled under dried atmosphere (in a silica gel desiccator), weighed (W3 gram). The water content is calculated from each of the obtained weights by using the following equation.

Water(%)=(W2−W3)÷(W2−W1)×100

### <Ingredients>

The ingredients (animal basic ingredients) of the pet food described above are not particularly limited, and the ingredients used for conventional pet food can be applied. For example, meat derived from domestic animals such as beef, pork, chicken and the like, and from various fish and the like can be used. In addition to these ingredients containing protein as a major component, grain containing carbohydrate components needed by pets, and vegetable foods containing dietary fibers may also be used.

The pet food described above may contain a water absorbing agent, which has a water absorbability. Types and amounts of the water absorbing agent described above are not particularly limited, and a variety of water absorbing agents can be used at, for example, 0.5 to 15% by weight based on granules of the pet food. In the present invention, cellulose not containing lignin is excluded from the water absorbing agents described above.

The water absorbing agent described above is preferably tasteless, odorless, and colorless, and examples thereof include lignocellulose, which is cellulose containing lignin, and polyhydric alcohol such as glycerin and the like. Sugars having water absorbability, such as sorbitol, trehalose and the like, and water soluble fibers, such as carrageenan, guar gum and the like can also be used as a water absorbing agent described above. One type of water absorbing agent described above may be used, or two or more types of the water absorbing agents may be used in combination.

When a pet food utilizing lignocellulose as a water absorbing agent and a pet food utilizing glycerin as a water absorbing agent are compared, the pet food utilizing lignocellulose may further improve palatability for pets.

When the pet food described above contains lignocellulose as the water absorbing agent described above, content of lignocellulose in the pet food, in which pet food granules are treated with heating and drying, followed by grease-coating, is preferably from 2.0 to 15.0% by weight, more preferably from 4.0 to 10.0% by weight, and still more preferably from 6.0 to 8.0% by weight.

When the content of lignocellulose is 2.0% by weight or more, the eaten pet food is facilitated to absorb digestive juice or water at gastrointestinal tracts, and the pet food becomes soft which reduces physical stimulation to the gastric wall or intestinal walls, and thereby vomiting in pets after meals can be suppressed. Also, when the content of lignocellulose is 15.0% by weight or more, dyspepsia can be prevented.

When the pet food described above contains glycerin as the moisture absorbent described above, content of glycerin in the pet food, in which pet food granules are treated with heating and drying, followed by grease-coating, is preferably from 2.0 to 15.0% by weight, more preferably from 4.0 to 10.0% by weight, and still more preferably from 6.0 to 8.0% by weight.

When the content of glycerin is 2.0% by weight or more, the eaten pet food is facilitated to absorb digestive juice or water in the gastrointestinal tract, and the pet food becomes soft which reduces physical stimulation to the gastric wall or intestinal walls, and thereby vomiting in pets after meals can be suppressed. Also, when the content of glycerin is 15.0% by weight or more, dyspepsia can be prevented.

The particulate pet food can be obtained by thoroughly mixing the ingredients described above and the water absorbing agent described above as needed, and granulating with a well-known extrusion forming machine (extruder). After granulation, grease may be added to the pet food by the method described below, so that the surface of the pet food is coated with the grease.

The shape of the pet food described above is not particularly limited, provided that the shape is a granule, and examples thereof include a spherical shape, a polyhedron shape, a column shape, a doughnut shape, a flat plate shape and a pill-shape, which are formed into pellets (granules). The sizes of such pellets are not particularly limited; however, for example, when the pellet is placed on a horizontal table and is observed from above, preferably the minor and major axes are from 3 to 25 mm, and the thickness from the bottom surface (lower end) of the pellet on a horizontal table to the top surface (upper end) is from 3 to 20 mm; more preferably the minor and major axes are from 3 to 11 mm, and the thickness is from 3 to 9 mm; and still more preferably the minor and major axes are from 5 to 9 mm, and the thickness is from 5 to 8 mm. With these suitable sizes described above, the pet food becomes easier for cats or small dogs (dogs having body weights of about 1 kg to 14 kg) to consume, and thus palatability of the present invention for such cats or small dogs can be further improved.

The pet food according to the present invention can be served to any pets including dogs and cats; however, it is preferably served to cats because the effect to suppress vomiting in cats is improved in the pet food.

In order to inform pet owners that the pet food of the first embodiment is a pet food particularly suitable for cats or dogs, when the pet food of the first embodiment is packaged and placed on sale, the pet food may be sold with a label indicating that the pet food is suitable for cats or dogs displayed appropriately on the packaging.

In the present description and the claims, the term “pet” describes an animal that is raised by people. In a more strict definition, a pet is an animal that is cherished by its owner. Further, “pet food” is food for a pet. The pet food according to the present invention can also be manufactured and sold as “animal feed”.

### <<Method of Manufacturing Pet Food>>

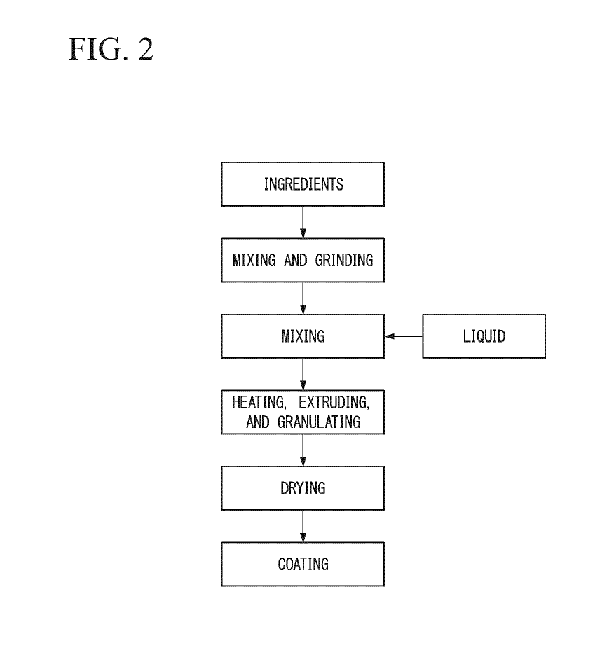

An example of the method of manufacturing the pet food according to the present invention will be explained below, by referring to the manufacturing flow chart shown in FIG. 2.

Ingredients which are preliminarily ground with a grinder or the like and liquids are mixed by using a preconditioner, and then warm water and steam are added thereto, and precooked at about 90 to 100° C. The liquids described above may contain the water absorbing agent described above such as lignocellulose and glycerin. Then, the precooked mixture is sent inside of an extruder barrel, and heating at about 120 to 135° C. and granulation are performed. Well-known extruders can be utilized for the heating and granulation. By the first heating treatment (precooking) at 90 to 100° C., starch ingredients are pre-gelatinized to improve tastes, and by the second heating treatment at 120 to 135° C., a portion of the ingredients is bloated or gasified, and thereby spaces are formed inside of food granules to improve texture.

After that, by drying at 80 to 120° C. until water content in the food granules becomes 7 to 11% by weight, and until the hardness described above is obtained, the pet food according to the first embodiment can be obtained.

After drying, the pet food according to the present invention may be further coated with a coating agent containing grease, seasonings such as an animal extract and amino acids, or fragrances and the like.

The types of ingredients typically used as a complete source of nutrition for pet food can be used as the ingredients described above. Important nutrients contained in the ingredients described above include proteins and carbohydrates.

Examples of the proteins include proteins derived from vegetables, proteins derived from animals, or mixtures thereof. Specific examples of the proteins derived from vegetables include gluten, wheat protein, soybean protein, rice protein, corn protein and the like. Specific examples of the proteins derived from animals include proteins of muscles, organs and the like of cattle, pigs, chickens and seafood, milk protein, or mixtures thereof. These proteins can be used as nutritional sources because they may contain fat, vitamins, iron and the like.

Preferable examples of the carbohydrates include carbohydrates of grain such as corn, wheat, barley, oats, rice, and soybeans. Such grain can be used as nutritional sources because they may contain proteins, ashes, minerals, vitamins and the like in addition to carbohydrates.

These ingredients include not only proteins and carbohydrates, but may also include vitamins, minerals, salts, fats, animal food extracts and the like added to the mixture described above.

For example, the ingredients can be mixed with a blend ratio (% by weight) shown in Table 1.

TABLE 1

| | Blend for | Blend for |
|---|---|---|
| | Cat | Dog |
| Grain (Corn, Flour, Corn gluten meal, Soybean | 55 to 75% | 65 to 85% |
| and the like) | | |
| Meat (Chicken meal, Pork meal, Chicken extract | 10 to 25% | 7 to 20% |
| and the like) | | |
| Seafood (Fish meal, Fish extract and the like) | 5 to 15% | 5 to 15% |
| Vitamins and Minerals (Vitamins are different | 2 to 5% | 2 to 5% |
| between for cats and for dogs) | | |
| Total | 100% | 100% |

A mixture of the ingredients described above can be obtained by mixing the ingredients at a desired blend ratio. As a method of obtaining the mixture, a conventional method in which the ingredients are mixed while grinding with a mixer can be used.

In the mixture described above, an amount of the water absorbing agent described above to main ingredients such as animal basic ingredients is not particularly limited, and as an example, when main ingredients are 100 parts by weight, the water absorbing agent is contained at 0.5 to 15 parts by weight. The main ingredients described above refer to grain, meats, and seafoods, as well as vitamins and minerals shown in Table 1. By preparing the mixture as stated, the pet food according to the first embodiment can easily be finished to have hardness within the aforementioned numerical value range.

Also, water content in the mixture described above is not particularly limited, and as an example, from 10 to 25% by weight of water is contained in the mixture. By preparing the mixture as stated, the pet food according to the present invention can easily be finished to have a hardness and a rate of water content within the aforementioned numerical value ranges.

A method of granulating the mixture described above is not particularly limited, provided that the pet food can be formed (molded) into a shape easier for pets to eat, and for example, a extrusion molding method employing an extruder is suitable. Well-known extruders with which mixtures of food products can be granulated into suitable sizes can be used. By using extruders, mixtures can be pressured, and thereby hardness of the obtained food granules can be controlled.

The “granulating” described above means that pet foods are molded into edible shapes for pets. In the present invention, a shape of the molded food granule (pellet) is not particularly limited, provided that pets can eat the food granules having the shapes, and for example, a variety of shapes, such as a spherical shape, a polyhedron shape, a column shape, a doughnut shape, a flat plate shape and a pill-shape can be applied. Also, a size of a molded food granule can be smaller, so that the granules can be eaten by pets in one bite for pets, or can be larger, so that pets can bite the granules multiple times.

The shapes and sizes of food granules are not particularly limited; however, when the food granule is placed on a horizontal table and is observed from above, it is preferably a pellet having the minor and major axes of 3 to 25 mm, and having the thickness, which is from the bottom surface (lower end) of the food granule on a horizontal table to the top surface (upper end), of 3 to 20 mm; more preferably a pellet having the minor and major axes of 3 to 11 mm, and having the thickness of 3 to 9 mm; and still more preferably a pellet having the minor and major axes of 5 to 9 mm, and having the thickness of 5 to 8 mm. With these shapes and sizes, when adjusting the water content within a given range in the heating and drying treatment performed later, the hardness can be easily adjusted within a preferable range.

In the granulation step, when the mixture is molded to be granulated, carbohydrates in the mixture can be pre-gelatinized by heating treatment. With the pre-gelatinization, the taste and texture of the obtained food granules can be improved.

The heating treatment described above can be performed in two steps. The following heating method with two-stages is an example.

A temperature of the first heating treatment (precooking) is not particularly limited; however, for example, it is performed preferably at 150° C. or lower, more preferably at 50 to 120° C., and still more preferably at 80 to 100° C. When heating at the temperature of above, hours for the heating treatment is preferably from 1 to 20 minutes, more preferably from 2 to 20 minutes, and still more preferably from 3 to 6 minutes.

A temperature of the second heating treatment is also not particularly limited; however, it is preferably performed at a temperature higher than that for the first heating treatment. An example of the heating condition is at 120 to 150° C., preferably for 1 to 20 minutes, more preferably for 0.5 to 10 minutes.

Devices and methods used for the heating treatment described above is not particularly limited; however, the first heating treatment is preferably performed by adding warm water and steam to ingredients and using a preconditioner, and the second heating treatment is preferably performed at the time of extruding food granules by using an extruder.

With the warm water and steam described above, water of 4 to 5% by weight can be added to the mixture described above.

### <Drying Treatment>

A method for drying the food granules described above obtained after heating is not particularly limited, and well-known methods such as a method for drying naturally, a method for drying by blowing warm air, a method for drying under vacuum, and a method for drying by freeze-drying can be applied. Among these drying methods, a method for drying by blowing warm air is preferable to improve the taste of the pet food.

When the drying described above is performed, the temperature of food granules and the temperature of the warm air described above, which blows to food granules are not particularly limited; however, the temperature of the warm air is preferably 150° C. or lower, more preferably from 90 to 120° C., and still more preferably from 100 to 110° C. When the drying is performed at the above temperatures, the heat treatment time is preferably 1 to 120 minutes, more preferably from 5 to 60 minutes, and still more preferably from 5 to 15 minutes. Although the lower limit value of a temperature of the warm air described above is not particularly limited, it is usually above room temperature (20° C.), and is preferably at 30° C. or above.

When the temperature and time are respectively greater than or equal to the lower limit values thereof, food granules can be dried in a short time. When the temperature is less than or equal to the upper limit value, food granules are prevented from being heated excessively.

A temperature for the heating treatment and a temperature for the drying treatment may be the same or different. With the drying treatment described above, the water content and the hardness of the food granules can be adjusted to given values.

After drying, the pet food according to the first embodiment can be further coated with a coating agent containing crude tallow, seasonings or fragrances and the like.

A method for coating is not particularly limited, and for example, a vacuum coating method can be used.

In the vacuum coating method described above, pressure is reduced as the coating agent described above is contacted with or attached to warmed food granules, and then slowly exposed to the atmosphere. The coating agent described above may be liquid or powder. With the coating described above, palatability for pets can be improved. Regardless of whether or not the coating is conducted pet food according to the first embodiment preferably has the hardness described above.

### EXAMPLES

The present invention is described below in further detail using a series of examples, but the present invention is in no way limited by the following examples.

Firstly, a mixture of the ingredients A, which contains grain, meat, seafood, vitamins and minerals, sugar (a sweetener containing sucrose, fructose or glucose), water, and glycerin, lignocellulose or cellulose was obtained with the blend ratios shown in Table 2.

The obtained mixture was heat-treated at 90 to 100° C. for 3 minutes by using a preconditioner, and granulated into substantially cylindrical food granules having a diameter of 8 mm and a height of 3 mm, by using an extruder. When granulation is performed by extrusion, the mixture was heat-treated at 120 to 135° C. for 30 seconds. After that, the obtained food granules were dried by a dryer at about 100 to 110° C. for about 15 minutes, and thus the pet food according to the present invention was obtained.

Coating treatments were performed on the pet food with a coating agent containing crude tallow, seasonings and fragrances, with weight ratios shown in Table 2, and the coated pet foods were used for tests for evaluating hardness and vomiting suppression. Each test was performed with the method described above. In addition, rates of water content of the pet foods after the coating treatment were measured by the method of heating and drying under normal pressure described above. The results are shown in Table 2.

TABLE 2□

| | Comparative | Comparative | | |
|---|---|---|---|---|
| | Example 1 | Example 2 | Example 1 | Example 2 |
| Ingredients A | 95.0% by | 87.5% by | 87.5% by | 88.0% by |
| | weight | weight | weight | weight |
| Glycerin | | | | 7.5% by |
| | | | | weight |
| Lignocellulose | | | 7.5% by | |
| | | | weight | |
| Cellulose | | 7.5% by | | |
| | | weight | | |
| Coating Grease | 5.0% by | 5.0% by | 5.0% by | 4.5% by |
| | weight | weight | weight | weight |
| Rate of water | 8.0% by | 8.0% by | 8.0% by | 10.0% by |
| content before | weight | weight | weight | weight |
| water absorption | | | | |
| Percentage content | 50% | 50% | 60% | 70% |
| of hardness of 2.5 | | | | |
| kgw or lower after | | | | |
| water absorption | | | | |
| Percentage content | 35% | 35% | 40% | 60% |
| of hardness of 1.3 | | | | |
| kgw or lower after | | | | |
| water absorption | | | | |
| Percentage of | 50% | 44% | 56% | 58% |
| suppression of | | | | |
| vomiting after | | | | |
| meal | | | | |

In Table 2, the content of granules having a hardness of 2.5 kgw or less after water absorption was determined as follows. 20 granules from each of the pet foods were soaked in the aforementioned diluted hydrochloric acid (pH 2.5) having a temperature of 20 to 25° C. for 10 minutes. Then, the granules were taken out of the diluted hydrochloric acid, and the hardness of the granules was measured as stated above within 1 to 2 minutes, and the percentage of granules having a hardness of 2.5 kgw or less was obtained.

Also in Table 2, the content of granules having a hardness of 1.3 kgw or less after water absorption was determined by measuring in the same manner as described above, and the percentage of granules having a hardness of 1.3 kgw or less was obtained.

In Table 2, the percentage of suppression of vomiting after meal was determined as follows. 17 cats were used as test subjects for each of the pet foods, 70 to 100 g of each pet food was given in one meal, frequencies of vomiting within 1 hour after meals were determined, and the percentage of cats in which the frequency of vomiting was observed to have decreased compared to before the evaluation tests were shown.

The results shown in Table 2 indicate that, compared to the pet foods of Comparative Examples 1 and 2, the pet foods of Examples 1 and 2 contain more granules having a hardness of 2.5 kgw or less or 1.3 kgw or less after water absorption, and further suppress vomiting after meals, and thus it can be clearly understood that the pet foods of Examples 1 and 2 are superior to those of Comparative Examples 1 and 2 to suppress vomiting.

Each of the formulations and combinations described in the above embodiments are merely examples, and additions, omissions, substitutions, and other modifications can be made without departing from the spirit or scope of the present invention. Accordingly, the present invention is not to be considered as being limited by the above embodiments, and is only limited by the scope of the claims.

### INDUSTRIAL APPLICABILITY

The pet food according to the present invention can be used widely in the field of food for pet animals.

1. A pet food comprising an aggregate of granules, wherein 60% or more of the granules in the aggregate have a hardness of 2.5 kgw or lower immediately after being soaked in diluted hydrochloric acid (pH 2.5) having a temperature of 20 to 25° C. for 10 minutes.

2. The pet food according to claim 1, wherein 40% or more of the granules in the aggregate have a hardness of 1.3 kgw or lower.

3. The pet food according to claim 1, wherein a water content of the granules before soaking is 7.0 to 11.0% by weight.

4. The pet food according to claim 1, which contains glycerin or lignocellulose.

5. The pet food according to claim 1, wherein a surface of the granules is coated with grease.

6. The pet food according to claim 1, wherein the granules are in the form of a pellet which has a minor axis of 3 to 25 mm, a major axis of 3 to 25 mm, and a thickness of 3 to 20 mm.

7. The pet food according to claim 1, wherein the pet food is a food for cats.
